(19) United States
(12) Patent Application Publication
(10) Pub. No.: US 2026/0087758 A1
(43) Pub. Date: Mar. 26, 2026

(54) GENERATING VOLUMETRIC REPRESENTATIONS FROM PANORAMA IMAGES

(71) Applicants: Adobe Inc., San Jose, CA (US); Laval University, Québec (CA)

(72) Inventors: Julien Olivier Victor Philip, London (GB); Yannick Hold-Geoffroy, Quebec City (CA); Kevin Blackburn-Matzen, Seattle, WA (US); Henrique Weber, Laval (CA); Jean-Francois Lalonde, Québec (CA)

(73) Assignee: Adobe Inc., San Jose, CA (US)

(21) Appl. No.: 18/898,632

(22) Filed: Sep. 26, 2024

(51) Int. Cl. G06T 19/20; G06T 3/4007; G06V 10/771; H04N 13/388; H04N 19/597

(52) U.S. Cl. CPC G06T 19/20; G06T 3/4007; G06V 10/771; H04N 13/388; H04N 19/597; G06T 2219/2004

(57) ABSTRACT

In implementation of techniques for generating volumetric representations from panorama images, a computing device implements a volumetric system to receive a two-dimensional panorama image. The volumetric system generates a feature map that indicates relationships between pixels of the two-dimensional panorama image. Based on the feature map, the volumetric system generates a volumetric representation by rearranging the pixels indicated by the feature map into a three-dimensional spherical map using a machine learning model.

### BACKGROUND

A panorama image is a digital image that captures a full 360° view in both horizontal and vertical directions around a camera. Unlike standard digital images that capture a limited field of view, the panorama image allows interactive panning of different angles from a single point of view at a center of the panorama image to view multiple directions of a depicted environment. Panorama images are typically generated by cameras using multiple lenses or by stitching together several images taken from a single camera using software. A variety of applications related to real estate, hospitality, architecture, and interior design leverage panorama images to convey 360° views of real-life or virtual environments. However, rendering panorama images in real-life scenarios causes errors and results in visual inaccuracies, computational inefficiencies, and increased power consumption in real world scenarios.

### SUMMARY

Techniques and systems for generating volumetric representations from panorama images are described. In an example, a volumetric system receives a two-dimensional panorama image. For instance, the two-dimensional panorama image is a surface of a sphere and depicts an indoor environment.

The volumetric system generates a feature map that indicates relationships between pixels of the two-dimensional panorama image. In some examples, the volumetric system determines depicted depths of the pixels of the two-dimensional panorama image and incorporates the depicted depths into the feature map.

Based on the feature map, the volumetric system generates a volumetric representation by rearranging the pixels indicated by the feature map into a three-dimensional spherical map using a machine learning model based on the feature map. The machine learning model is trained on multiple two-dimensional panorama images and/or random camera views of a training volumetric representation. For example, the three-dimensional spherical map is a concentric tri-sphere representation.

The volumetric system then presents the volumetric representation for display in a user interface. The pixels of the volumetric representation convey information about lighting, shadows, and reflections related to multiple viewpoints of content of the two-dimensional panorama image. In some examples, the volumetric system receives an input specifying a three-dimensional location relative to the volumetric representation to position a virtual three-dimensional object and inserts the virtual three-dimensional object at the three-dimensional location relative to the volumetric representation for display in the user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for generating volumetric representations from panorama images as described herein.

FIG. 2 depicts a system in an example implementation showing operation of a mesh progression module for generating volumetric representations from panorama images.

FIG. 3 depicts an example of receiving an input including a panorama image.

FIG. 4 depicts an example of an architecture for generating volumetric representations from panorama images.

FIG. 5 depicts an example of a spherical map for generating volumetric representations from panorama images.

FIG. 6 depicts an example of an output including a volumetric representation.

FIG. 7 depicts an example of object insertion into a volumetric representation.

FIG. 8 depicts a procedure in an example implementation of generating volumetric representations from panorama images.

FIG. 9 depicts a procedure in an additional example implementation of generating volumetric representations from panorama images.

FIG. 10 depicts a procedure in an additional example implementation of generating volumetric representations from panorama images.

FIG. 11 illustrates an example system including various components of an example device that can be implemented as any type of computing device as described and/or utilized with reference to FIGS. 1-11 to implement embodiments of the techniques described herein.

### DETAILED DESCRIPTION

### Overview

A panorama image is a digital image that captures a 360° view of an environment. The panorama image, for instance, is a two-dimensional, spherical-shaped representation that depicts different angles of the environment from a single point of view at the center of the panorama image. However, the panorama image lacks three-dimensional qualities. For instance, the single point of view is fixed in the center of the panorama image and cannot be moved. For example, the panorama image depicts an interior of a grocery store. A user cannot move the point of view down an isle of the store because the point of view is fixed in place and is merely able to pan around, observing the surroundings in two dimensions. Therefore, lighting and shadows on virtual objects are fixed in place on the panorama image because the virtual objects are two-dimensional. Additionally, the virtual objects cannot be positioned or moved in the panorama image.

Conventional panorama rendering techniques attempt to use triplane neural radiance fields (NeRFs) to generate three-dimensional representations based on panorama images. However, the resulting three-dimensional representations are improperly scaled because the triplane NeRF is based on a grid, which does not translate pixels accurately from a spherical panorama image.

Techniques and systems are described for generating volumetric representations from panorama images that overcome these limitations. To increase its three-dimensional properties, the panorama image is transformed into a volumetric representation, which translates the environment depicted in the panorama image into three dimensions. In the above example, the grocery store aisles are three-dimensional in the volumetric representation, which supports moving the point of view down an aisle, unlike in the two-dimensional panorama image. To generate the volumetric representation, a feature map that indicates relationships between pixels of the panorama image is generated. The pixels of the feature map are then rearranged into a three-dimensional spherical map based on the relationships using a machine learning model, resulting in the volumetric representation. Therefore, utilizing the three-dimensional spherical map instead of the triplane NeRF used by the conventional panorama rendering techniques retains the scale of objects depicted in the panorama image while accurately transforming the panorama image into the volumetric representation.

In an example, a volumetric system begins by receiving an input including a panorama image depicting a 360° view of an interior of a restaurant. The panorama image depicts continuous views in horizontal and vertical directions from a central point, which coincides with the placement of the camera at the center of the interior of the restaurant. For instance, the panorama image depicts the floor, walls, and ceiling of the restaurant. However, because the panorama image is two-dimensional, tables, chairs, and other objects depicted in the panorama image are also two-dimensional and cannot be moved or viewed from different angles.

To generate a volumetric representation of the interior of the restaurant, the volumetric system first generates a feature map based on the panorama image. The feature map is a two-dimensional representation that identifies pixels corresponding to features of the panorama image, including edges, textures, shapes, objects, or other visual attributes of the panorama image.

To translate pixels indicted by the feature map into three dimensions, the volumetric system then generates a three-dimensional spherical map based on the feature map. The three-dimensional spherical map is a tri-sphere representation composed of concentric spheres that map the features of the feature map in a three-dimensional, 360° space. For example, the three-dimensional spherical map is an alternative to the triplane NeRF, which maps features onto three two-dimensional planes. For instance, the three-dimensional spherical map indicates information related to depicted depths of pixels of the panorama image that is not indicated by the feature map.

The volumetric system then generates a volumetric representation based on the three-dimensional spherical map. To do this, the volumetric system performs three-dimensional interpolation on the three-dimensional spherical map by estimating values for pixels in a three-dimensional space based on known values of the pixels on the three-dimensional spherical map before passing the resulting information through a neural renderer to produce a raw image. The volumetric system then performs upsampling on the raw image to generate the volumetric representation.

The volumetric representation conveys spatially-varying information related to lighting, shadows, and reflections for multiple viewpoints of content of the panorama image. In this example, the volumetric representation depicts the interior of the restaurant in three dimensions. No longer confined to two dimensions, the tables, the chairs, and the other objects display realistic changes in lighting and shadows when the point of view is changed in the volumetric representation.

In some implementations, the volumetric system receives an additional input including a three-dimensional location relative to the volumetric representation to position a virtual three-dimensional object. For example, the volumetric system receives an input specifying a virtual bottle of wine to position on one of the tables of the restaurant in the volumetric representation. Because the volumetric representation is a three-dimensional version of two-dimensional environment depicted in the panorama image, the volumetric representation supports insertion of the virtual three-dimensional object at the three-dimensional location relative to the volumetric representation for display in the user interface.

Generating volumetric representations from panorama images in this manner overcomes the limitations of conventional panorama rendering techniques that are limited to displaying inaccurate three-dimensional representations of panorama images. For example, rearranging pixels from a feature map into a three-dimensional spherical map translates depth information from the feature map back into a 360° format. This allows for accurate generation of volumetric representations, which provide a more immersive experience than conventional panorama rendering techniques that utilize triplane NeRFs. Generating volumetric representations from panorama images also supports insertion of three-dimensional objects into the volumetric representation, which is not possible using the conventional panorama rendering techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

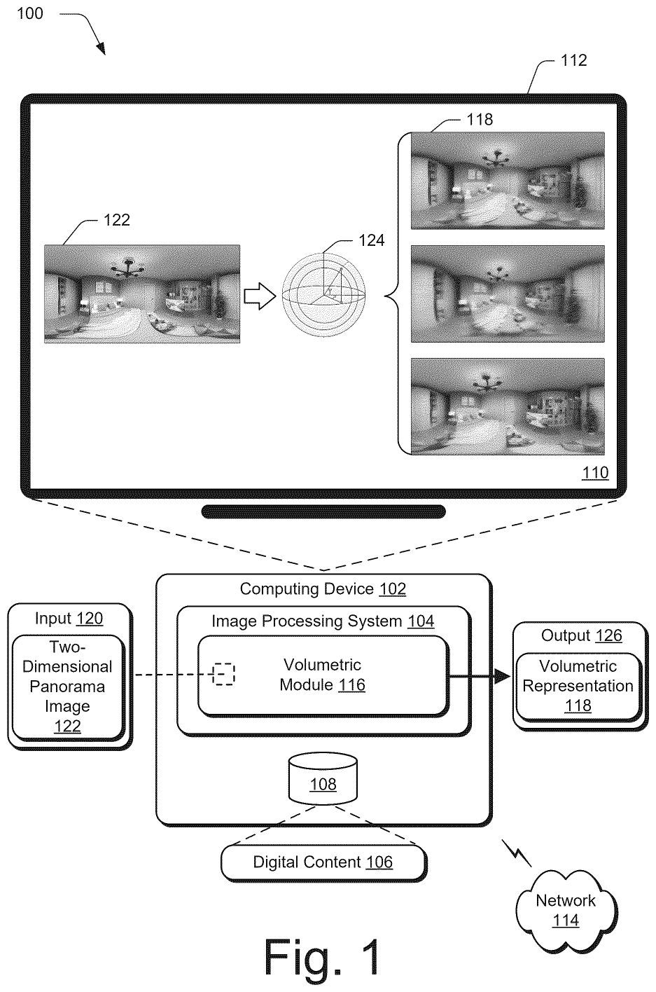

FIG. 1 is an illustration of a digital medium environment 100 in an example implementation that is operable to employ techniques and systems for generating volumetric representations from panorama images described herein. The illustrated digital medium environment 100 includes a computing device 102, which is configurable in a variety of ways.

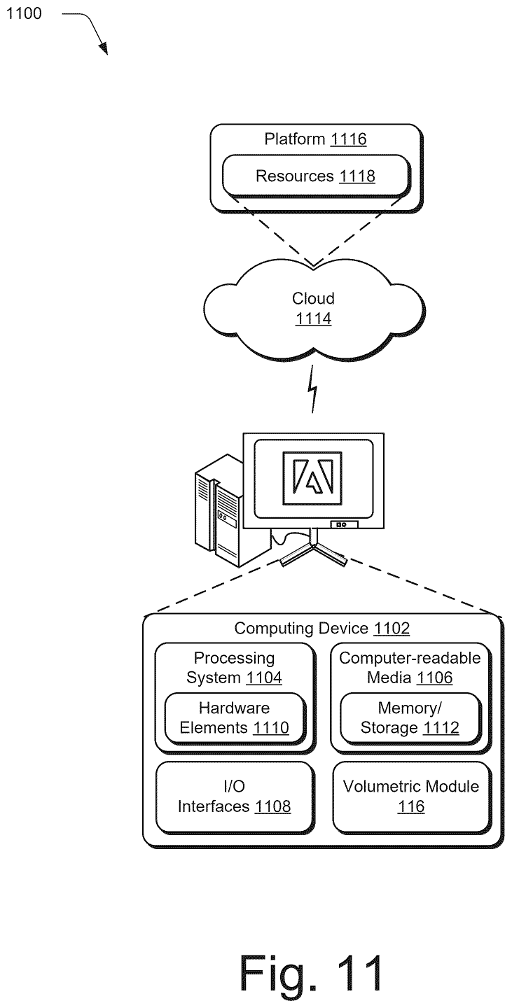

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 11.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a volumetric module 116 which is illustrated as incorporated by the image processing system 104 to process the digital content 106. In some examples, the volumetric module 116 is separate from the image processing system 104 such as in an example in which the volumetric module 116 is available via the network 114.

The volumetric module 116 is configured to generate a volumetric representation 118. For example, the volumetric module 116 first receives an input 120 including a two-dimensional panorama image 122. The two-dimensional panorama image 122 is a two-dimensional, full-circle panoramic image that captures a complete 360° view of a scene in both horizontal and vertical directions. The two-dimensional panorama image 122 enables a viewer to view a scene in multiple directions (left, right, up, down) from a single viewpoint. In this example, the two-dimensional panorama image 122 depicts a living room, and the two-dimensional panorama image 122 enables viewers to view scenes by pivoting or rotating the angle of view from the single viewpoint of the two-dimensional panorama image 122. However, the single viewpoint is fixed, meaning the viewer sees the 360° scene in two dimensions, and therefore the two-dimensional panorama image 122 lacks three-dimensional features, including lighting, shadows, and reflections that change depending on a viewpoint.

To generate a volumetric representation 118 that incorporates three-dimensional qualities into the two-dimensional panorama image 122, the volumetric module 116 generates a feature map that indicates relationships between pixels of the two-dimensional panorama image 122. The feature map is a two-dimensional representation that identifies features of the two-dimensional panorama image 122, including edges, textures, shapes, objects, or other visual attributes of the two-dimensional panorama image 122. In some examples, the volumetric module 116 preprocesses the two-dimensional panorama image 122 before using an algorithm to detect features of the two-dimensional panorama image 122 to generate the feature map.

The volumetric module 116 then re-shapes the feature map into a three-dimensional spherical map 124 using a machine learning model. The three-dimensional spherical map 124 is a tri-sphere representation composed of concentric spheres that map the features of the feature map in a three-dimensional, 360° space. For example, the three-dimensional spherical map 124 is a spherical counterpart to a triplane neural radiance field (NeRF), which maps features onto three two-dimensional planes. The machine learning model determines an arrangement to translate pixels from the two-dimensional feature map to the three-dimensional spherical map 124, which is three-dimensional. For instance, the three-dimensional spherical map 124 indicates information related to depicted depths of pixels of the two-dimensional panorama image 122 that is not indicated by the feature map.

In some examples, the volumetric module 116 then decodes and upsamples the three-dimensional spherical map 124 to generate the volumetric representation 118. In this example, the volumetric representation 118 depicts a virtual, three-dimensional environment of the living room depicted by the two-dimensional panorama image 122. After the volumetric module 116 generates the volumetric representation 118, the volumetric module 116 then produces an output 126 including the volumetric representation 118 for display in the user interface 110. In some examples, the volumetric module 116 receives an additional input including a three-dimensional location relative to the volumetric representation 118 to position a virtual three-dimensional object and inserts the virtual three-dimensional object at the three-dimensional location relative to the volumetric representation 118 for display in the user interface 110. In some examples, the volumetric representation 118 is used to determine information related to the scene depicted in the volumetric representation 118, including occlusions, shadows, and lighting.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

Generating Volumetric Representations from Panorama Images

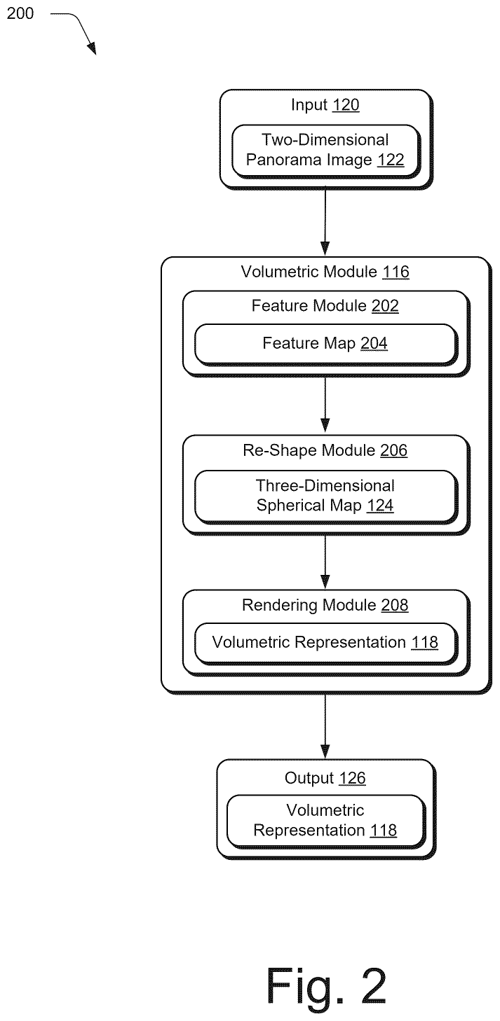

FIG. 2 depicts a system 200 in an example implementation showing operation of the volumetric module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-11.

To begin in this example, a volumetric module 116 receives an input 120 including a two-dimensional panorama image 122. The two-dimensional panorama image 122 is a two-dimensional, 360° digital image that depicts an indoor scene. For example, the two-dimensional panorama image 122 depicts an indoor environment surrounding the camera that captured the two-dimensional panorama image 122. Because the two-dimensional panorama image 122 provides a 360° view, the two-dimensional panorama image 122 depicts continuous views in horizontal and vertical directions from a central point, which coincides with the placement of the camera.

The volumetric module 116 includes a feature module 202 that generates a feature map 204 based on the two-dimensional panorama image 122. The feature map 204 is a two-dimensional representation that identifies features of the two-dimensional panorama image 122, including edges, textures, shapes, objects, or other visual attributes of the two-dimensional panorama image 122. In some examples, the feature module 202 preprocesses the two-dimensional panorama image 122, including rescaling, color normalization, or noise reduction to generate the feature map 204. The feature module 202 leverages an extraction algorithm to identify points, edges, or textures represented by pixels of the two-dimensional panorama image 122. In some examples, the feature module 202 also generates key point descriptors that are numerical vectors to capture a local appearance and texture around the key points. The feature module 202 then conducts feature mapping across the two-dimensional panorama image 122. Because the two-dimensional panorama image 122 is spherically-shaped, this involves unwrapping the two-dimensional panorama image 122 in some examples. During the feature mapping, the feature module 202 constructs the feature map 204 by mapping elements depicted by pixels of the two-dimensional panorama image 122 as a matrix or a tensor.

The volumetric module 116 also includes a re-shape module 206 that generates a three-dimensional spherical map 124 based on the feature map 204. The three-dimensional spherical map 124 is a tri-sphere representation composed of concentric spheres that map the features of the feature map in a three-dimensional, 360° space. For example, the three-dimensional spherical map 124 is a spherical counterpart to a triplane neural radiance field (NeRF), which maps features onto three two-dimensional planes. The machine learning model determines an arrangement to translate pixels from the two-dimensional feature map to the three-dimensional spherical map 124, which is three-dimensional. For instance, the three-dimensional spherical map 124 indicates information related to depicted depths of pixels of the two-dimensional panorama image 122 that is not indicated by the feature map.

The volumetric module 116 also includes a rendering module 208 that generates a volumetric representation 118 based on the three-dimensional spherical map 124. The rendering module 208 performs trilinear interpolation, or other three-dimensional interpolation, on the three-dimensional spherical map 124 by estimating values in a three-dimensional space before passing the resulting information through a neural renderer, which includes a decoder and a volume rendering model and produces a raw image. The rendering module 208 then performs upsampling on the raw image to generate the volumetric representation 118.

The volumetric representation 118 conveys information about lighting, shadows, and reflections related to multiple viewpoints of content of the two-dimensional panorama image 122. The volumetric module 116 then generates an output 126 including the volumetric representation 118 for display in the user interface 110. In some examples during training the volumetric module 116 includes a discriminator 418 that determines a level of realism for the volumetric representation 118.

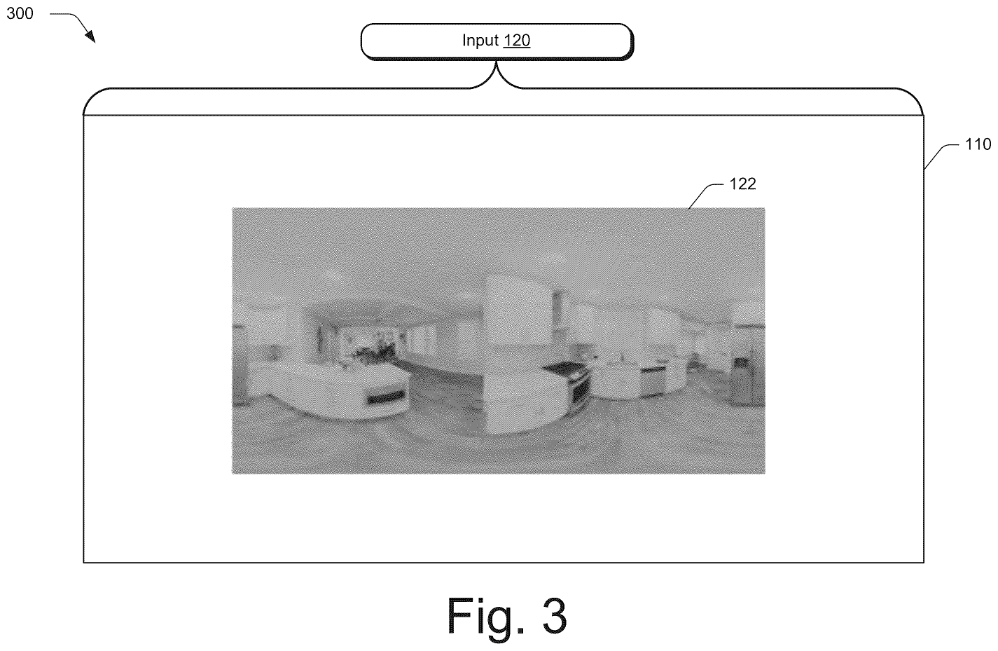

FIGS. 3-7 depict stages of generating volumetric representations from panorama images. In some examples, the stages depicted in these figures are performed in a different order than described below.

FIG. 3 depicts an example 300 of receiving an input including a panorama image. As illustrated, the volumetric module 116 receives an input 120 including a two-dimensional panorama image 122. In this example, the two-dimensional panorama image 122 depicts a kitchen inside a house.

The two-dimensional panorama image 122 is a two-dimensional, full-circle panoramic image that captures a complete 360° view of a scene in both horizontal and vertical directions. The two-dimensional panorama image 122 is created by capturing and stitching together a series of overlapping images taken from different directions around a central point using an image capture device. This involves overlapping image shots with the next by 20-30 percent. The overlap allows stitching software to align the images by identifying common features in the overlapping areas.

Once the images are captured, stitching software processes them by aligning the images and blending them together to create a seamless view. This involves adjusting the colors, brightness, and exposure between images to eliminate visible seams. In some examples, the stitched images are mapped onto an equirectangular projection, a format that stretches the image horizontally and vertically to cover the 360-degree space in the form of the two-dimensional panorama image 122. The two-dimensional panorama image 122 facilitates viewing using a panorama viewer or other application in a user interface 110, allowing users to view different angles of the scene depicted in the two-dimensional panorama image 122 interactively, either by dragging the image using a touch screen or physically moving a mobile device.

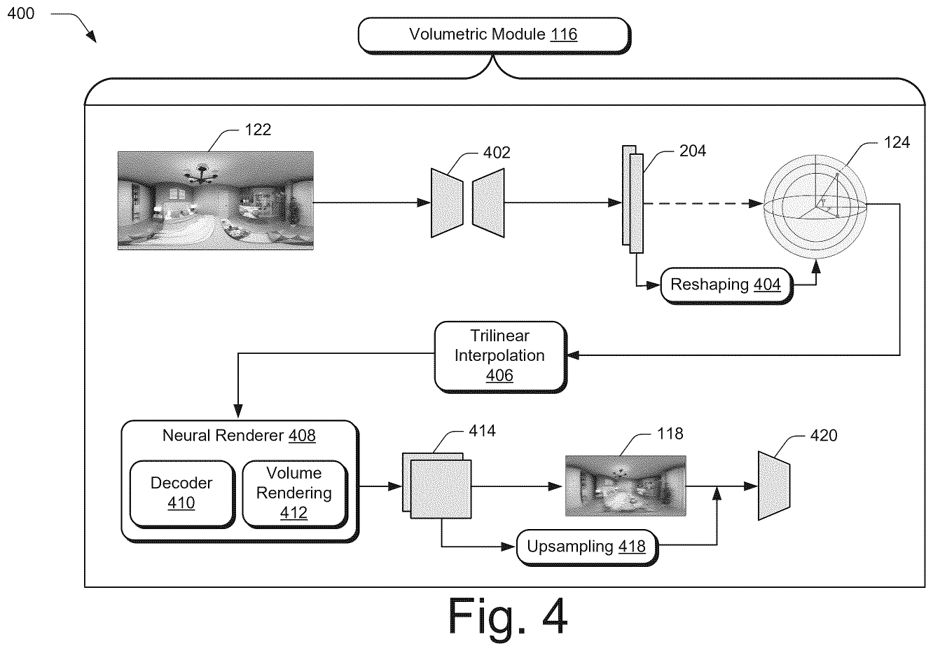

FIG. 4 depicts an example 400 of an architecture for generating volumetric representations from panorama images. As illustrated in this example, the volumetric module 116 receives a two-dimensional panorama image 122 with 7 channels (RGB, depth, and normals). Although the two-dimensional panorama image 122 is depicted in this example as a rectangle, the two-dimensional panorama image 122 is a two-dimensional, 360° image depicting an uninterrupted view of an environment. The volumetric module 116 determines depths for pixels of the two-dimensional panorama image 122 using a co-modulated generative adversarial network 402 to estimate monocular depths for a depth map. The co-modulated generative adversarial network 402 introduces a form of synchronization or co-modulation during synthesis of the features extracted from images. During training, the co-modulated generative adversarial network 402 produces depth maps modulated based on the discriminator's learned features, allowing for improved realism and consistency in generated images.

The volumetric module 116 then calculates normals from the depth map, which are vectors that are perpendicular to a surface at a given point. The volumetric module 116 then outputs a feature map 204 of dimensions of 256×256×96 pixels based on the depth map and the normals. The feature map 204, for instance, includes information related to depicted depths of pixels and normal attributes of the two-dimensional panorama image 122.

The volumetric module 116 also modifies ray directions for ray tracing to simulate light interactions on object surfaces depicted in the two-dimensional panorama image 122. Originally, ray directions are computed based on a perspective camera model. The camera intrinsic parameters are used to transform the pixel coordinates into camera-relative three-dimensional points. In this example, however, the ray directions are computed based on an omnidirectional camera model. First, the pixel coordinates are used to calculate spherical coordinates θ and φ:

$$θ = π \times ( u - 1 )$$

$$ϕ = π \times v$$

The volumetric module 116 then converts the spherical coordinates to Cartesian coordinates on a unit sphere:

$$x = sin ( ϕ ) \times sin ( θ )$$

$$y = cos ( ϕ )$$

$$z = - sin ( ϕ ) \times cos ( θ )$$

The resulting (x, y, z) represent the ray directions emanating from the camera locations and spreading out in different directions on the surface of a sphere.

Because neural renderers in this example include skip-connections, the two-dimensional panorama image 122 is incorrectly queried by a neural renderer if projected directly into a tri-plane format. To address this, the volumetric module 116 performs reshaping 404 on the feature map 204 to generate a three-dimensional spherical map 124. The three-dimensional spherical map 124 includes 3 spheres that share a center and vary in diameter. To query a given three-dimensional position p∈ [symbol] ³, p is normalized, then its u, v coordinates are calculated as:

$$u = 1 + ( 1 / π ) \times {tan}^{- 1} ( {p}_{x} , - {p}_{z} )$$

$$v = ( 1 / π ) \times {cos}^{- 1} ( {p}_{y} )$$

The volumetric module 116 performs trilinear interpolation 406 between the three spheres of the three-dimensional spherical map 124. In examples, however, the volumetric module 116 performs other three-dimensional interpolation. For this, a third index is calculated as follows:

$${d}_{n} = \frac{log ( 1 + ‖ p ‖ )}{log ( 1 + max ( D ) )} \times f \times 2 - 1$$

where max(D) is the maximum depth value in our dataset, and f=(nₛ−0.5)/nₛ (with nₛ=3 being the number of spheres) is a scaling factor used to map the projected points to up to half of the depth dimension. The volumetric module 116 samples the three-dimensional spherical map 124 with bilinear interpolation at the location (u, v, dₙ).

The rendering module 208 performs trilinear interpolation, or other three-dimensional interpolation, on the three-dimensional spherical map 124 before passing the resulting information through a neural renderer 408, which includes a decoder 410 and a volume rendering model 412, which produces a raw image 414. The rendering module 208 then performs upsampling 416 on the raw image 414 to generate the volumetric representation 118.

To accommodate the two-dimensional panorama image 122, which is 360° and therefore is not represented using a common coordinate system, the volumetric module 116 uses depth maps to cause the network to learn three-dimensional scene geometry. Because the dataset does not have ground-truth geometry information, an existing 360° monocular depth estimator is used. To further increase the geometric cues, the volumetric module 116 calculates the normal map from the depth and provides them together with the RGB channel, resulting in an input having 7 channels.

Because the depth maps d have a high dynamic range, the volumetric module 116 compresses them into a predefined range to facilitate training using the following compression:

$$d = \frac{ln ( 1 + d )}{ln ( 1 + max ( D ) )}$$

where D represents the set of all depth maps. In the case of the dataset, max(D)=20. The In operator compresses large values while leaving small values relatively unchanged, and overall division brings the range of the entire dataset to the [0,1] interval.

Regarding the input camera pose, the dataset modality does not support a common reference for camera poses. In response, the volumetric module 116 uses the network to render panoramas from random camera poses during training. Therefore, once the network receives a panorama as input, it is encouraged to generate a plausible panorama from a given viewpoint. Additionally, the network is forced to reconstruct the input panorama instead of outputting a random panorama.

The volumetric module 116 uses a non-saturating generative adversarial network loss function, and L1 density regularization. L1 density regularization encourages sparsity in a model's parameters or output by applying Lasso regularization (L1 norm), to penalize certain parts of the network. To reconstruct the input panorama, the camera pose is set to be at the origin of the coordinate system twenty-five percent of the time during training in this example, and a reconstruction loss is used between the prediction and the ground-truth image.

Regarding training, the volumetric module 116 uses a minibatch standard deviation layer at the end of the discriminator 418, equalized learning rates for the trainable parameters, exponential moving average on the generator weights, and non-saturating logistic loss with L1 regularization. The minibatch standard deviation layer aids the discriminator 418 detecting whether an input image is real or fake by considering the variability within a minibatch of inputs and by computing the standard deviation across a minibatch of data, aggregating the information, and then incorporating the information as an additional feature for the discriminator. In this example, the batch size is 8, and the training duration is 40 epochs.

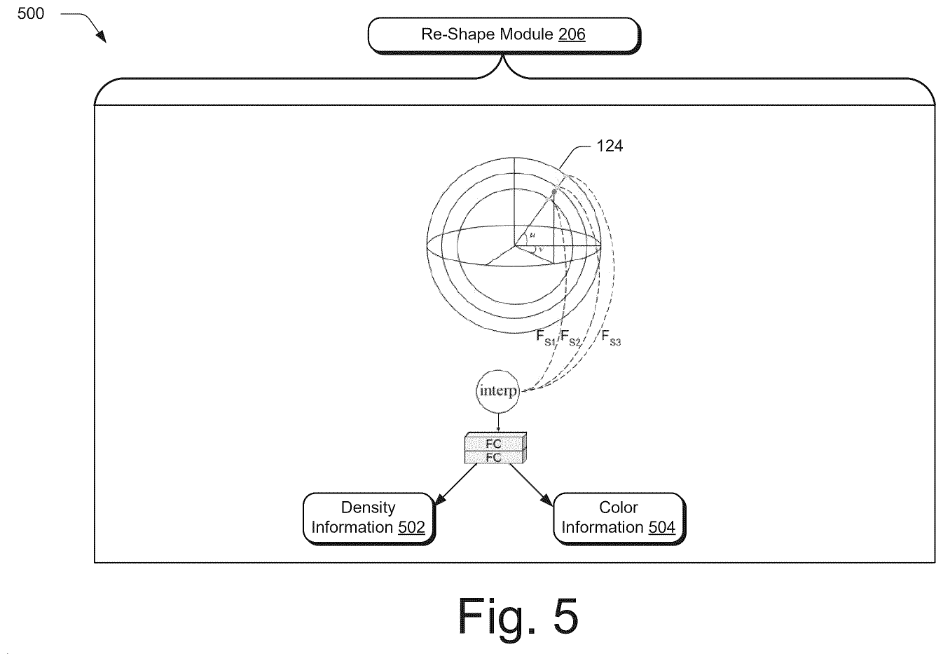

FIG. 5 depicts an example 500 of a spherical map for generating volumetric representations from panorama images. FIG. 5 is a continuation of the example described in FIG. 4.

The three-dimensional spherical map 124 includes three concentric spherical layers that have varying sizes. This allows the three-dimensional spherical map 124 to efficiently handle 360° panoramas. For instance, the three-dimensional spherical map 124 scales effectively with resolution, allowing for enhanced detail and an increased level of performance compared to conventional representations. The conventional representations include neural radiance fields (NeRFs) and triplane NeRFs. The conventional representations, for instance, are slow to query and scale poorly with resolution. Additionally, the conventional representations are not accurately generated based on the two-dimensional panorama image 122 because the conventional representations do not sufficiently model features from a 360° spherical input. For this reason, the three-dimensional spherical map 124 is an improvement over the conventional representations.

The three-dimensional spherical map 124 includes density information 502 and color information 504 that is interpolated from the three concentric spherical layers of the three-dimensional spherical map 124. The density information 502 and the color information 504 is interpreted by the rendering module 208 when generating the volumetric representation 118.

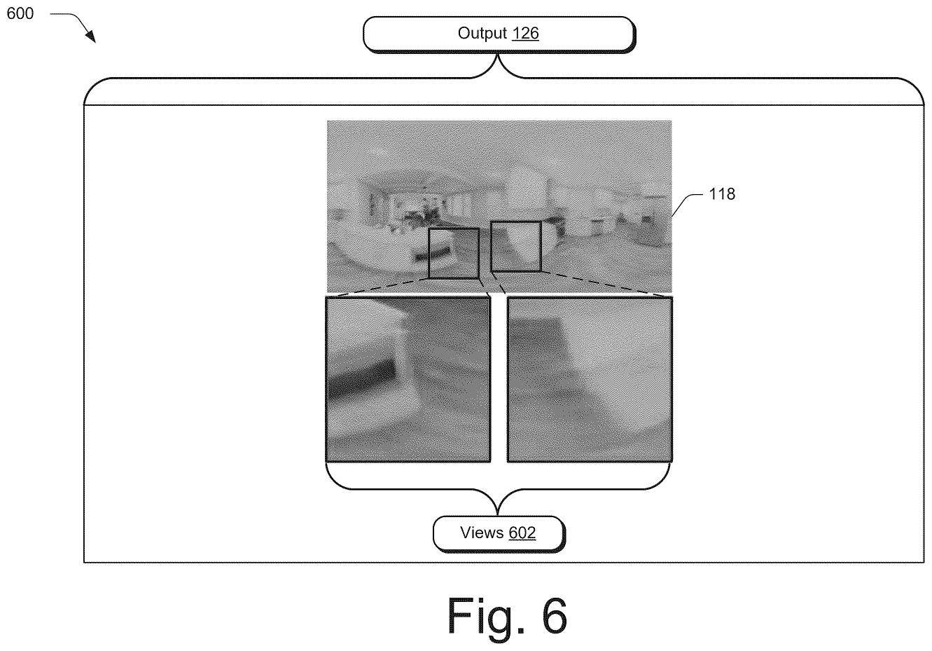

FIG. 6 depicts an example 600 of an output including a volumetric representation. FIG. 6 is a continuation of the example described in FIG. 5. As explained above, the two-dimensional panorama image 122 in this example is a two-dimensional, full-circle panoramic image that captures a complete 360° view of a scene in both horizontal and vertical directions. The two-dimensional panorama image 122 enables a viewer to view a scene in multiple directions (left, right, up, down) from a single viewpoint. In this example, the two-dimensional panorama image 122 depicts a kitchen, and the two-dimensional panorama image 122 enables viewers to view scenes by pivoting or rotating the angle of view from the single viewpoint of the two-dimensional panorama image 122. However, the single viewpoint is fixed. For instance, the viewer sees the 360° scene in two dimensions, meaning the two-dimensional panorama image 122 lacks three-dimensional features, including lighting, shadows, and reflections that change depending on a viewpoint.

The output 126 offers an improvement over the two-dimensional panorama image 122 that incorporates three-dimensional qualities into the two-dimensional panorama image 122, so that the volumetric representation 118 supports movement in the virtual environment depicted by the volumetric representation 118. In this example, for instance, views 602 are depicted showing portions of the volumetric representation 118 that depict varying amounts of light, shadows, and reflections depending on a viewpoint in the volumetric representation 118. Users therefore are able to move around and experience virtual objects or other features depicted by the volumetric representation 118 in three-dimensions, including different views that exhibit varying degrees of light, shadows, and reflections on virtual materials depending on a point of view.

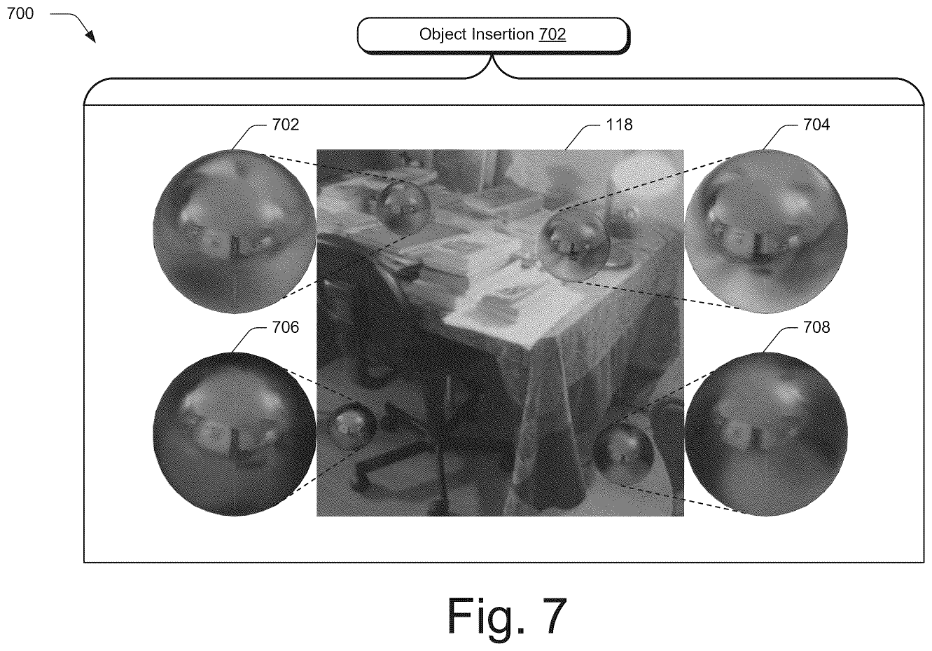

FIG. 7 depicts an example 700 of object insertion into a volumetric representation. FIG. 7 is a continuation of the example described in FIG. 5. After the volumetric module 116 generates the volumetric representation 118, the volumetric module 116 inserts objects for display relative to the volumetric representation 118.

In this example, the volumetric module 116 receives an additional input including a three-dimensional location relative to the volumetric representation 118 to position a virtual three-dimensional objects, including first object 702, second object 704, third object 706, and fourth object 708. The virtual three-dimensional objects are glossy spheres having a surface that reflects the environment around the glossy spheres.

The volumetric module 116 inserts the virtual three-dimensional object at the three-dimensional location relative to the volumetric representation 118 for display in the user interface 110. Because the volumetric representation 118 features location-dependent light estimation, the inserted virtual three-dimensional objects reflect light according to their respective locations. For instance, the first object 702 and the second object 704 are inserted on the table depicted in the volumetric representation 118, while the third object 706 and the fourth object 708 are inserted below the table in the volumetric representation 118. The first object 702 and the second object 704 therefore reflect light and imagery surrounding the top of the table, while the third object 706 and the fourth object 708 reflect light and imagery surrounding the bottom of the table.

The light and reflections on the virtual three-dimensional objects vary depending on a position of a viewpoint within the volumetric representation 118. For example, a user navigates within the environment depicted in the volumetric representation 118, and the light and reflections on the virtual three-dimensional objects change accordingly.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-11.

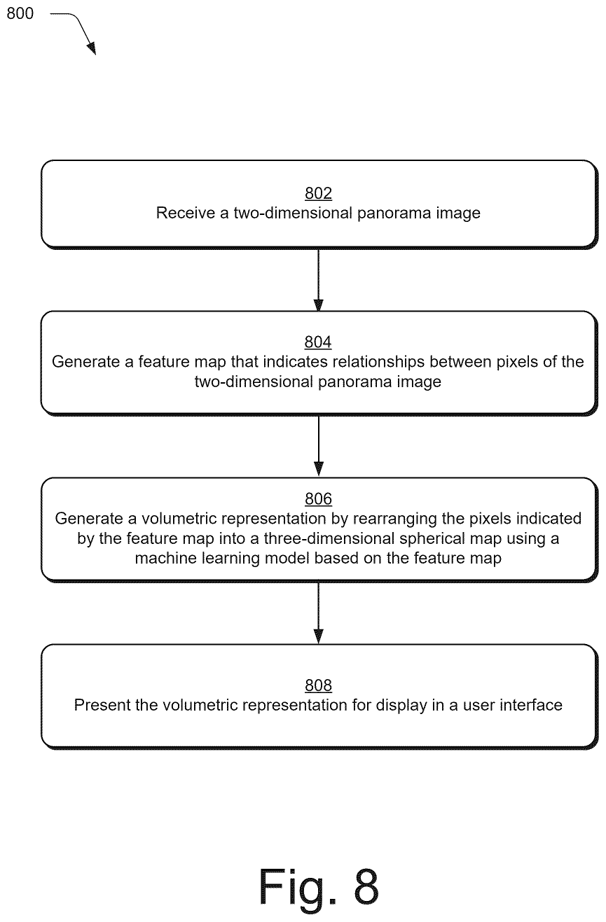

FIG. 8 depicts a procedure 800 in an example implementation of generating volumetric representations from panorama images. At block 802 a two-dimensional panorama image is received. For example, the two-dimensional panorama image is a surface of a sphere and depicts an indoor environment.

At block 804, a feature map 204 that indicates relationships between pixels of the two-dimensional panorama image 122 is generated. Some examples further comprise determining depicted depths of the pixels of the two-dimensional panorama image 122 and incorporating the depicted depths into the feature map 204.

At block 806, a volumetric representation 118 is generated by rearranging the pixels indicated by the feature map 204 into a three-dimensional spherical map 124 using a machine learning model based on the feature map 204. In some examples, the machine learning model is trained on multiple two-dimensional panorama images. Additionally or alternatively, the machine learning model is trained on random camera views of a training volumetric representation. Some examples further comprise tri-linearly interpolating points from the three-dimensional spherical map 124 onto the volumetric representation 118. For example, the three-dimensional spherical map 124 is a concentric tri-sphere representation. In some examples, pixels of the volumetric representation 118 convey information about lighting, shadows, and reflections related to multiple viewpoints of content of the two-dimensional panorama image 122.

At block 808, the volumetric representation 118 is presented for display in a user interface 110. Some examples further comprise receiving an input specifying a three-dimensional location relative to the volumetric representation 118 to position a virtual three-dimensional object and inserting the virtual three-dimensional object at the three-dimensional location relative to the volumetric representation 118 for display in the user interface 110.

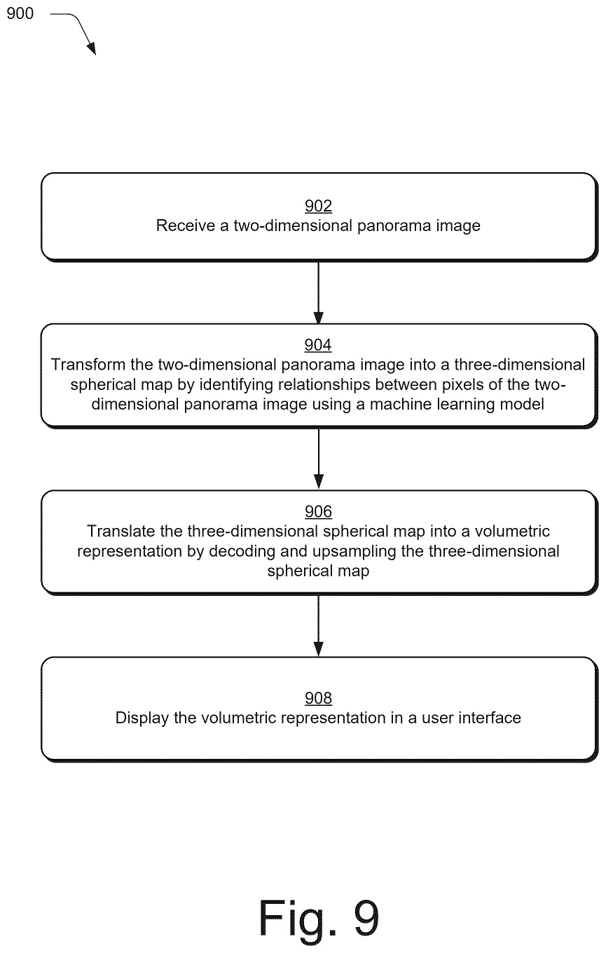

FIG. 9 depicts a procedure 900 in an additional example implementation of generating volumetric representations from panorama images. At block 902, a two-dimensional panorama image 122 is received. In some examples, the two-dimensional panorama image 122 is a surface of a sphere and depicts an indoor environment.

At block 904, the two-dimensional panorama image 122 is transformed into a three-dimensional spherical map 124 by identifying relationships between pixels of the two-dimensional panorama image using a machine learning model. In some examples, the machine learning model is trained on multiple two-dimensional panorama images. In other examples, the machine learning model is trained on random camera views of a training volumetric representation.

At block 906, the three-dimensional spherical map 124 is translated into a volumetric representation 118 by decoding and upsampling the three-dimensional spherical map 124. In some examples, the depicted depths of the pixels of the two-dimensional panorama image 122 are determined, and the three-dimensional spherical map 124 is translated into the volumetric representation 118 based on the depicted depths.

At block 908, the volumetric representation 118 is displayed in a user interface 110. For example, pixels of the volumetric representation 118 convey information about lighting, shadows, and reflections related to multiple viewpoints of content of the two-dimensional panorama image 122. Some examples further comprise receiving an input specifying a three-dimensional location relative to the volumetric representation 118 to position a virtual three-dimensional object and inserting the virtual three-dimensional object at the three-dimensional location relative to the volumetric representation 118 for display in the user interface 110.

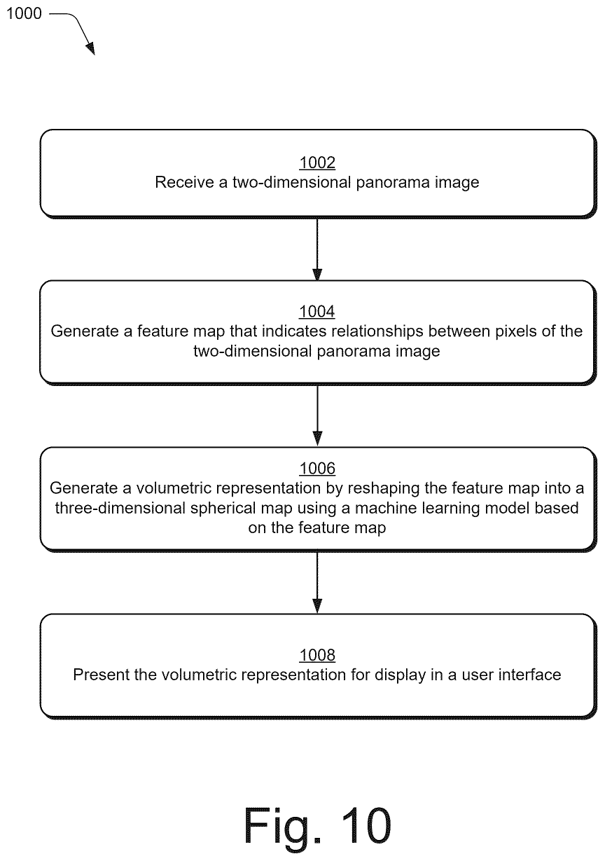

FIG. 10 depicts a procedure 1000 in an additional example implementation of generating volumetric representations from panorama images. At block 1002, a two-dimensional panorama image 122 is received. For example, the two-dimensional panorama image 122 is a surface of a sphere and depicts an indoor environment.

At block 1004, a feature map that indicates relationships between pixels of the two-dimensional panorama image is generated. Some examples further comprise determining depicted depths of the pixels of the two-dimensional panorama image 122 and incorporating the depicted depths into the feature map 204.

At block 1006, a volumetric representation is generated by reshaping the feature map 204 into a three-dimensional spherical map 124 using a machine learning model based on the feature map 204. For example, the machine learning model is trained on multiple two-dimensional panorama images and/or random camera views of a training volumetric representation. In some examples, points from the three-dimensional spherical map 124 are tri-linearly interpolated onto the volumetric representation 118. For example, the three-dimensional spherical map 124 is a concentric tri-sphere representation.

At block 1008, the volumetric representation 118 is presented for display in a user interface 110. The pixels of the volumetric representation 118 convey information about lighting, shadows, and reflections related to multiple viewpoints of content of the two-dimensional panorama image 122.

### Example System and Device

FIG. 11 illustrates an example system generally at 1100 that includes an example computing device 1102 that is representative of one or more computing systems and/or devices that implement the various techniques described herein. This is illustrated through inclusion of the volumetric module 116. The computing device 1102 is configurable, for example, as a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interface 1108 that are communicatively coupled, one to another. Although not shown, the computing device 1102 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing system 1104. The instructions and/or functions are executable/operable by one or more articles of manufacture (for example, one or more computing devices and/or processing systems 1104) to implement techniques, modules, and examples described herein.

The techniques described herein are supported by various configurations of the computing device 1102 and are not limited to the specific examples of the techniques described herein. This functionality is also implementable through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized when computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

What is claimed is:

1. A method comprising:
receiving, by a processing device, a two-dimensional panorama image;
generating, by the processing device, a feature map that indicates relationships between pixels of the two-dimensional panorama image; and
generating, by the processing device, a volumetric representation by rearranging the pixels indicated by the feature map into a three-dimensional spherical map using a machine learning model based on the feature map.

2. The method of claim 1, wherein the two-dimensional panorama image is a surface of a sphere and depicts an indoor environment.

3. The method of claim 1, further comprising:
receiving an input specifying a three-dimensional location relative to the volumetric representation to position a virtual three-dimensional object;
inserting the virtual three-dimensional object at the three-dimensional location relative to the volumetric representation for display in a user interface; and
presenting, by the processing device, the volumetric representation, including the virtual three-dimensional object, for display in the user interface.

4. The method of claim 1, wherein the machine learning model is trained on multiple two-dimensional panorama images.

5. The method of claim 1, wherein the machine learning model is trained on random camera views of a training volumetric representation.

6. The method of claim 1, further comprising determining depicted depths of the pixels of the two-dimensional panorama image and incorporating the depicted depths into the feature map.

7. The method of claim 1, further comprising tri-linearly interpolating points from the three-dimensional spherical map onto the volumetric representation.

8. The method of claim 1, wherein the three-dimensional spherical map is a concentric tri-sphere representation.

9. The method of claim 1, wherein pixels of the volumetric representation convey information about lighting, shadows, and reflections related to multiple viewpoints of content of the two-dimensional panorama image.

10. A non-transitory computer-readable storage medium storing executable instructions, which when executed by a processing device, cause the processing device to perform operations comprising:
receiving a two-dimensional panorama image;
transforming the two-dimensional panorama image into a three-dimensional spherical map by identifying relationships between pixels of the two-dimensional panorama image using a machine learning model;
translating the three-dimensional spherical map into a volumetric representation by decoding and upsampling the three-dimensional spherical map; and
displaying the volumetric representation in a user interface.

11. The non-transitory computer-readable storage medium of claim 10, wherein the two-dimensional panorama image is a surface of a sphere and depicts an indoor environment.

12. The non-transitory computer-readable storage medium of claim 10, further comprising:
receiving an input specifying a three-dimensional location relative to the volumetric representation to position a virtual three-dimensional object; and
inserting the virtual three-dimensional object at the three-dimensional location relative to the volumetric representation for display in the user interface.

13. The non-transitory computer-readable storage medium of claim 10, wherein the machine learning model is trained on multiple two-dimensional panorama images.

14. The non-transitory computer-readable storage medium of claim 10, wherein the machine learning model is trained on random camera views of a training volumetric representation.

15. The non-transitory computer-readable storage medium of claim 10, further comprising determining depicted depths of the pixels of the two-dimensional panorama image and translating the three-dimensional spherical map into the volumetric representation based on the depicted depths.

16. The non-transitory computer-readable storage medium of claim 10, wherein pixels of the volumetric representation convey information about lighting, shadows, and reflections related to multiple viewpoints of content of the two-dimensional panorama image.

17. A system comprising:
means for receiving a two-dimensional panorama image;
means for generating a feature map that indicates relationships between pixels of the two-dimensional panorama image;
means for generating a volumetric representation by reshaping the feature map into a three-dimensional spherical map using a machine learning model based on the feature map; and
means for presenting the volumetric representation for display in a user interface.

18. The system of claim 17, wherein the two-dimensional panorama image is a surface of a sphere and depicts an indoor environment.

19. The system of claim 17, further comprising determining depicted depths of the pixels of the two-dimensional panorama image and incorporating the depicted depths into the feature map.

20. The system of claim 17, wherein pixels of the volumetric representation convey information about lighting, shadows, and reflections related to multiple viewpoints of content of the two-dimensional panorama image.
